(19) United States
(12) Patent Application Publication
(10) Pub. No.: US 2011/0155091 A1
(43) Pub. Date: Jun. 30, 2011

(54) INLAY PART FOR A PISTON OF AN INTERNAL COMBUSTION ENGINE AND PISTON OR PISTON HEAD PROVIDED WITH THE INLAY PART

(75) Inventors: Helmut Kollotzek, Mutlangen (DE); Sven Schilling, Korb (DE); Juergen Rudi, Ludwigsburg (DE)

(73) Assignee: MAHLE International GmbH, Stuttgart (DE)

(21) Appl. No.: 12/737,364

(22) PCT Filed: Jul. 2, 2009
(86) PCT No.: PCT/DE2009/000935

§ 371 Date: Mar. 10, 2011

(30) Foreign Application Priority Data
Jul. 5, 2008 (DE) 10 2008 031 863.9

(51) Int. Cl. F02F 3/00

(52) U.S. Cl. 123/193.6

(57) ABSTRACT

The present invention relates to an inlay part (10, 110) for a piston of an internal combustion engine, wherein the piston has a piston head (21, 121) which is provided with a piston crown (22) which has a combustion depression (23), with an encircling fire land (24) and with an encircling ring part and with an encircling cooling duct (12) which is arranged at the level of the ring part. It is provided according to the invention that the inlay part (10, 11) is formed as a single-piece component which has an encircling cooling duct (12), a ring carrier region (11) and a depression region (13, 113) for a depression edge reinforcement. The present invention also relates to a piston or piston head (21, 121) provided with such an inlay part (10, 110).

The present invention relates to an inlay part for a piston of an internal combustion engine, whereby the piston has a piston head that is provided with a piston crown having a combustion bowl, a circumferential top land, and a circumferential ring belt, as well as a circumferential cooling channel disposed at the height of the ring belt. The present invention furthermore relates to such a piston or piston head for an internal combustion engine.

In modern internal combustion engines, the pistons are exposed to great thermal and mechanical stress. Pistons for diesel engines, which are generally cast from a light-metal alloy, for example an aluminum alloy, particularly have multiple regions subject to great stress. These include, in particular, the region of the uppermost ring groove, as well as the region of the bowl edge and of the bowl base. It is known to stabilize the region of the uppermost ring groove by means of a separate ring insert that can also have a cooling channel structure (see DE 197 50 021 A1). It is furthermore known to reinforce the bowl edge by means of an armoring (see DE 10 2004 056 519 A1).

Such reinforcements of the piston are produced by means of casting inlay parts into the piston. It is problematic in this connection to fix the inlay parts in place in the piston casting mold in a precise position and with as little play as possible, and, at the same time, to dispose a salt core for the cooling channel in the piston casting mold in as precise a position as possible, and fix it in place.

The task of the present invention thus consists in making available an inlay part that can be fixed in place in the piston casting mold in as precise a position as possible, with little effort, and effectively reinforces a region of a piston that is subject to great stress.

The solution consists in an inlay part having the characteristics of claim 1, as well as in a piston or a piston head having the characteristics of claim 9. According to the invention, it is provided that the inlay part is configured as a one-piece component that has a circumferential cooling channel, a ring insert region, as well as a bowl region for a bowl edge reinforcement, bowl base reinforcement. The piston or piston head according to the invention is characterized in that it contains an inlay part that is configured as a one-piece component and has a circumferential cooling channel, a ring insert, as well as a bowl edge reinforcement and bowl base reinforcement.

The inlay part according to the invention is characterized in that it has structures that serve as reinforcements for two different, highly stressed regions in the finished piston. Thus, only a single inlay part has to be disposed in the casting mold and fixed in place in a precise position, in order to effectively reinforce not only the uppermost ring groove but also the bowl edge and/or bowl base. The inlay part according to the invention can be disposed in the casting mold for the piston or the piston head in known manner, simply and in a precise position, and attached there, namely in the same manner as a rough ring insert casting is disposed in a casting mold in the state of the art, and fixed in place. Consequently, the effort for production of the piston or piston head according to the invention is significantly reduced.

Furthermore, the inlay part according to the invention is provided with a cooling channel. This means that a separate salt core is no longer required for the casting mold. Furthermore, the cooling channel is necessarily disposed in the casting mold with the same position precision as the inlay part according to the invention itself. The inlay part according to the invention is fixed in place in the casting mold, as has been described above, by way of its structure that corresponds to a rough ring insert casting. This is done with a greater position precision than in the case of laying a salt core in, so that the cooling channel in the finished piston has a greater position precision than was possible up to now, in the state of the art. Furthermore, the cooling channel in the inlay part according to the invention can be positioned particularly close to the uppermost ring groove, thereby automatically resulting in a particularly slight distance from the bowl edge and from the bowl base, as well. In this manner, a better cooling effect is achieved not only in the region of the thermally particularly stressed uppermost ring groove, but also in the region of the combustion bowl.

In summary, there are therefore numerous advantages as compared with the state of the art: Significant simplification of the casting process for the piston according to the invention, and, at the same time, effective reinforcement not only of the uppermost ring groove but also of the bowl edge and bowl base, minimization of the position tolerance for the cooling channel, optimized positioning of the cooling channel and thus good cooling of the uppermost ring groove and the combustion bowl.

Advantageous further developments are evident from the dependent claims.

In a preferred embodiment, the inlay part according to the invention can have an additional structure, namely a rough casting for an at least partial bowl base reinforcement. In this manner, the reinforcement of the combustion bowl is further improved.

Furthermore, the inlay part according to the invention can have structures for a shape-fit connection with the piston or piston head, for example in the form of undercuts and/or projections, which supplement the force-fit connection between inlay part and piston.

The inlay part according to the invention can consist of any desired material. Suitable materials are, for example, fiber-reinforced materials and, in particular, materials such as those used for production of the known ring inserts. These include, in particular, a form of austenitic cast iron known as NiResist. In this case, it is practical to subject the inlay part according to the invention to a known alfination process before it is cast into the piston or piston head.

The inlay part according to the invention is preferably configured as a cast part. The piston or piston head according to the invention is cast from an aluminum alloy, for example, and is suitable, in this form, for all engines, but particularly for diesel engines.

Exemplary embodiments of the present invention are explained in greater detail in the following, using the attached drawings. These show, in a schematic representation, not true to scale:

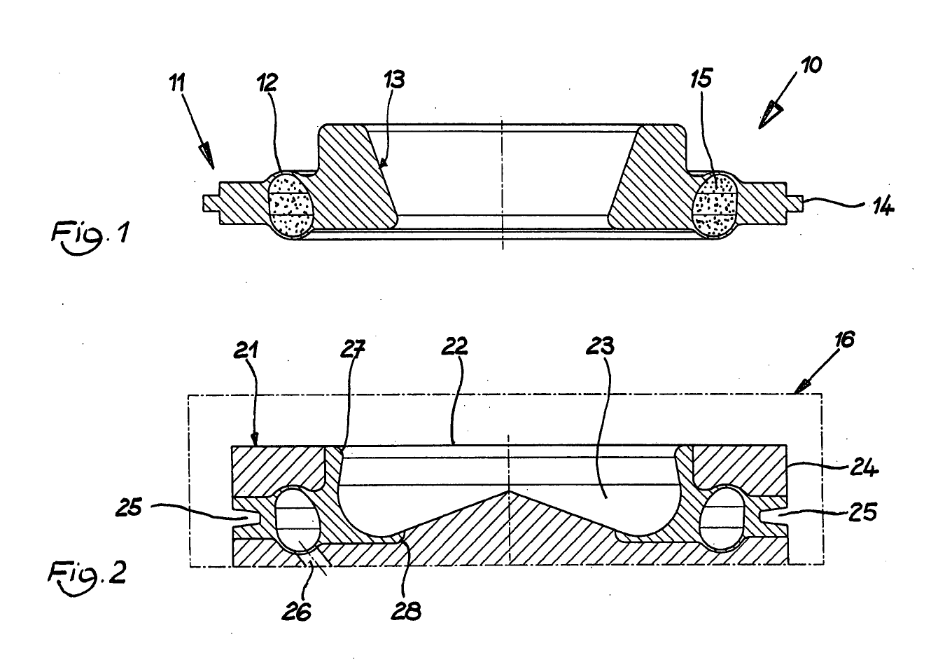

FIG. 1 a first exemplary embodiment of an inlay part according to the invention, in section;

FIG. 2 a partial view of a first exemplary embodiment of a finished piston head according to the invention, in section,

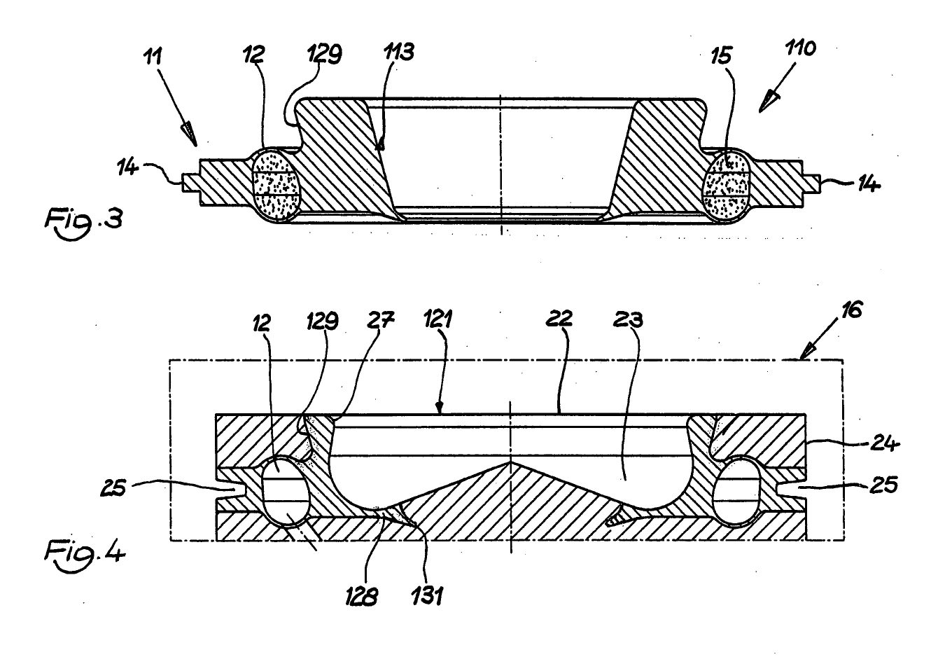

FIG. 3 a second exemplary embodiment of an inlay part according to the invention, in section;

FIG. 4 a partial view of a second exemplary embodiment of a finished piston head according to the invention, in section.

FIG. 1 shows a first exemplary embodiment of an inlay part 10 according to the invention. The inlay part 10 comprises a circumferential ring insert region 11 having a circumferential land 14, a circumferential cooling channel 12, as well as a bowl region 13. In the exemplary embodiment, the inlay part 10 is cast in one piece from a material called a NiResist material. NiResist materials are understood to be austenitic cast-iron materials, particularly those having lamellar or spherical graphite. The cooling channel 12 is produced in known manner, in that a pressed salt core 15 is laid into the casting mold for the inlay part 10, and held in position as precisely as possible on mandrels or pins. The material for the inlay part 10 is cast around the salt core 15, which remains in the finished, cast inlay part 10 at first. The finished, cast inlay part 10 can be machined in known manner, if necessary.

The exemplary embodiment of the inlay part 10 shown in FIG. 1 is cast into a piston or a piston head for an internal combustion engine, according to the invention. The piston or piston head can consist, for example, of a light-metal material, particularly of an aluminum alloy. In this case, the inlay part 10 is alfinated in known manner before casting takes place, for example it is dipped into an aluminum-silicon melt, thereby causing a layer called an Alfin layer, composed of iron aluminides, to form on the surface of the inlay part 10. This Alfin layer serves as a bonding layer between the material of the piston or piston head and the material of the inlay part 10.

The inlay part 10, prepared in this way, is inserted into the casting mold of the piston or piston head to be produced, and held precisely in position, whereby the circumferential land 14 serves as a contact medium. These measures are known, since conventional rough ring insert castings are held in a piston casting mold in the same manner. Now the piston material is cast around the inlay part 10, so that a rough casting 16 is obtained. The contours of the resulting rough casting 16 in the region of the later piston head are indicated with a dot-dash line in FIG. 2.

The rough casting 16 is now machined to produce the finished piston or piston head. In this connection, the inlay part 10 is machined at the same time, in order to produce the final structures of the piston or piston head. FIG. 2 shows details of an exemplary embodiment of a piston head 21 according to the invention. The piston head 21 is provided with a piston crown 22 that has a combustion bowl 23, a circumferential top land 24, and a circumferential ring belt (not shown).

The inlay part 10 is machined in such a manner that the ring insert region 11 in FIG. 1 now forms a known ring insert 25, which is disposed in the uppermost ring groove of the ring belt. The circumferential cooling channel 12 is furthermore disposed at the height of the ring belt and closely adjacent to the combustion bowl 23. The salt core was removed in known manner, in that an oil outflow bore 26 was introduced into the piston head 21 and the salt core was flushed out through the oil outflow bore, by means of water. The bowl region 13 of the inlay part 10 shown in FIG. 1 was machined in such a manner that a circumferential bowl edge reinforcement 27 as well as a partial bowl base reinforcement 28 are obtained.

FIGS. 3 and 4 show another exemplary embodiment of an inlay part 110 according to the invention, as well as of a piston head 121 according to the invention, in each instance. In this connection, structures that agree with the exemplary embodiments according to FIGS. 1 and 2 were provided with the same reference symbols. The single difference consists in the configuration of the bowl region 113 of the inlay part 110 or the bowl base reinforcement 128 of the piston head 121. The bowl region 113 of the inlay part 110 is provided with a circumferential undercut 129 along its outer mantle surface.

The bowl region 113 furthermore has a circumferential projection in its lower inner region. The undercut 129 and the projection 131 can be produced by means of casting, using a corresponding casting mold. However, an insert part according to FIG. 1 can also be cast, and the undercut 129 and the projection 131 can be formed by means of corresponding machining of the inlay part 113.

From FIG. 4, it is clearly evident that the undercut 129 and the projection 131 bring about an additional shape-fit connection of the inlay part 113 with the piston head 121.

1. Inlay part (10, 110) for a piston of an internal combustion engine, whereby the piston has a piston head (21, 121) that is provided with a piston crown (22) having a combustion bowl (23), a circumferential top land (24), and a circumferential ring belt, as well as a circumferential cooling channel (12) disposed at the height of the ring belt, wherein the inlay part (10, 110) is configured as a one-piece component that has a circumferential cooling channel (12), a ring insert region (11), as well as a bowl region (13, 113) for a bowl edge reinforcement.

2. Inlay part according to claim 1, wherein it has a bowl region (13, 113) for an at least partial bowl base reinforcement.

3. Inlay part according to claim 1, wherein it has structures (129, 131) for a shape-fit connection with the piston.

4. Inlay part according to claim 3, wherein the structures are configured as undercuts (129) or projections (131).

5. Inlay part according to claim 1, wherein it consists of a fiber-reinforced material.

6. Inlay part according to claim 1, wherein it consists of austenitic cast iron.

7. Inlay part according to claim 6, wherein it is subjected to an alfination process.

8. Inlay part according to claim 1, wherein it is configured as a cast part.

9. Piston head (21, 121) of a piston for an internal combustion engine, whereby the piston head (21, 121) is provided with a piston crown (22) having a combustion bowl (23), a circumferential top land (24), and a circumferential ring belt, as well as a circumferential cooling channel (12) disposed at the height of the ring belt, wherein the piston head (21, 121) contains an inlay part (10, 110) that is configured as a one-piece component and has a circumferential cooling channel (12), a ring insert (25), as well as a bowl edge reinforcement (27).

10. Piston head according to claim 9, wherein the inlay part (10, 110) forms an at least partial bowl base reinforcement (28).

11. Piston head according to claim 10, wherein the piston head (121) and the inlay part are connected with one another by means of projections (131) and/or undercuts (129), in shape-fit manner.

12. Piston head according to claim 9, wherein it is cast from a light-metal alloy.

13. Piston for an internal combustion engine, whereby the piston has a piston head (21, 121) that is provided with a piston crown (22) having a combustion bowl (23), a circumferential top land (24), and a circumferential ring belt, as well as a circumferential cooling channel (12) disposed at the height of the ring belt, wherein the piston contains an inlay part (10, 110) that is configured as a one-piece component and has a circumferential cooling channel (12), a ring insert (25), as well as a bowl edge reinforcement (27).

14. Piston according to claim 13, wherein the inlay part (10, 110) forms an at least partial bowl base reinforcement (28).

15. Piston according to claim 14, wherein the piston and the inlay part (110) are connected with one another by means of projections (131) and/or undercuts (129), in shape-fit manner.

16. Piston according to claim 13, wherein it is cast from a light-metal alloy.

17. Piston according to claim 13, namely a piston for diesel engines cast from an aluminum alloy.
